(19) United States
(12) Patent Application Publication
(10) Pub. No.: US 2022/0004438 A1
(43) Pub. Date: Jan. 6, 2022

(54) GPU PROGRAM MULTI-VERSIONING FOR HARDWARE RESOURCE UTILIZATION

(71) Applicant: QUALCOMM Incorporated, San Diego, CA (US)

(72) Inventors: Chunling HU, Campbell, CA (US); Chu-Cheow LIM, San Jose, CA (US)

(21) Appl. No.: 16/920,156

(22) Filed: Jul. 2, 2020

(51) Int. Cl. G06F 9/50; G06F 8/41; G06F 9/48; G06T 1/20

(52) U.S. Cl. CPC G06F 9/5055; G06F 8/451; G06F 2209/501; G06T 1/20; G06F 9/4881

(57) ABSTRACT

The present disclosure relates to methods and apparatus for graphical processing. A processing unit may generate or utilize different versions of a GPU program based on hardware resources allocated to the GPU program at runtime. The processing unit may be configured to generate a first version of a GPU program that accesses a resource from a global memory of the processing unit 120 and a second version of the GPU program that access the resource from a fast shared resource of the processing unit 120. The processing unit may utilize the first version of the GPU program if the resource cannot be stored on the fast shared resource allocated to the GPU program at run time, and may utilize the second version of the GPU program if the resource can be stored on the fast shared resource allocated to the GPU program at run time.

### TECHNICAL FIELD

The present disclosure relates generally to processing systems and, more particularly, to one or more techniques for display or graphics processing.

### INTRODUCTION

Computing devices often utilize a graphics processing unit (GPU) to accelerate the rendering of graphical data for display. Such computing devices may include, for example, computer workstations, mobile phones such as so-called smartphones, embedded systems, personal computers, tablet computers, and video game consoles. GPUs execute a graphics processing pipeline that includes one or more processing stages that operate together to execute graphics processing commands and output a frame. A central processing unit (CPU) may control the operation of the GPU by issuing one or more graphics processing commands to the GPU. Modern day CPUs are typically capable of concurrently executing multiple applications, each of which may need to utilize the GPU during execution. A device that provides content for visual presentation on a display generally includes a GPU.

### SUMMARY

The following presents a simplified summary of one or more aspects in order to provide a basic understanding of such aspects. This summary is not an extensive overview of all contemplated aspects, and is intended to neither identify key elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include a memory and a processor coupled to the memory. The processor may be configured to determine a set of resources, wherein each resource of the set of resources is accessed by a plurality of threads of a graphics processing unit (GPU) program through memory access instructions; generate a first version of the GPU program accessing a resource of the set of resources from a global memory; generate a second version of the GPU program accessing the resource from a fast shared resource; and transmit the first version of the GPU program and the second version of the GPU program to a second processor.

In some aspects, the second processor may be configured to determine whether to store the resource on the global memory or the fast shared resource based on hardware resources available for the GPU program, and utilize the second version of the GPU program if the resource is to be stored on the fast shared resource.

In some aspects, the second processor may be configured to utilize the first version of the GPU program if the resource is to be stored on the global memory.

In some aspects, the processor may be further configured to determine a benefit value for each resource of the set of resources based on a cost function, and select the resource from the set of resources based on the benefit value of the resource.

In some aspects, the cost function may be based on a number of reduced memory access instructions associated with storing the resource on the fast shared resource, an amount of saved memory access bandwidth associated with storing the resource on the fast shared resource, or an amount of reduced register use associated with storing the resource on the fast shared resource.

In some aspects, the processor may be further configured to determine a benefit value for each resource of the set of resources based on a cost function, select the resource from the set of resources based on the benefit value of the resource, select a second resource from the set of resources based on the benefit value of the second resource, and generate a third version of the GPU program accessing the second resource from the fast shared resource. The second processor may be configured to determine whether to store the second resource on the global memory or the fast shared resource based on the hardware resources available for the GPU program, and utilize the third version of the GPU program if the second resource is to be stored on the fast shared resource.

In some aspects, the second processor may be configured to utilize the first version of the GPU program if the resource and the second resource are both to be stored on the global memory, wherein the first version of the GPU program accesses the resource and the second resource from the global memory.

In some aspects, the processor may be configured to select the resource from the set of resources and select the second resource from the set of resources by determining that the benefit value of the resource and the benefit value of the second resource both exceed a threshold value.

In some aspects, the processor may be configured to select the second resource from the set of resources by determining that the benefit value of the second resource is at least a threshold percentage of the benefit value of the first resource.

In some aspects, each resource of the set of resources may be uniformly accessed by the plurality of threads of the GPU program.

In some aspects, the resource is a texture or a buffer.

In another aspect of the disclosure, a method, a computer-readable medium, and an apparatus are provided. The apparatus may include a memory and a processor coupled to the memory. The processor may be configured to receive a first version of a graphics processing unit (GPU) program and a second version of the GPU program, the first version of the GPU program being configured to access a resource from a global memory, the second version of the GPU program being configured to access the resource from a fast shared resource; determine whether to store the resource on the global memory or the fast shared resource based on hardware resources available for the GPU program; and utilize the second version of the GPU program if the resource is to be stored on the fast shared resource.

In some aspects, the processor may be further configured to utilize the first version of the GPU program if the resource is to be stored on the global memory.

In some aspects, the first version of the GPU program and the second version of the GPU program may be received from a second processor configured to determine a set of resources comprising the resource, wherein each resource of the set of resources is accessed by a plurality of threads of the GPU program through memory access instructions, generate the first version of the GPU program accessing the resource from the global memory, and generate the second version of the GPU program accessing the resource from the fast shared resource.

In some aspects, each resource of the set of resources may be uniformly accessed by the plurality of threads of the GPU program.

In some aspects, the second processor may be configured to determine a benefit value for each resource of the set of resources based on a cost function, and select the resource from the set of resources based on the benefit value of the resource.

In some aspects, the cost function may be based on a number of reduced memory access instructions associated with storing the resource on the fast shared resource, an amount of saved memory access bandwidth associated with storing the resource on the fast shared resource, or an amount of reduced register use associated with storing the resource on the fast shared resource.

In some aspects, the processor may be further configured to receive a third version of the GPU program accessing a second resource from the fast shared resource, determine whether to store the second resource on the global memory or the fast shared resource based on the hardware resources available for the GPU program, and utilize the third version of the GPU program if the second resource is to be stored on the fast shared resource.

In some aspects, the processor may be further configured to utilize the first version of the GPU program if the resource and the second resource are both to be stored on the global memory, wherein the first version of the GPU program accesses the resource and the second resource from the global memory.

In some aspects, the resource may be a texture or a buffer.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example content generation system, in accordance with one or more techniques of this disclosure.

FIG. 2 is a block diagram illustrating the example processing unit of FIG. 1, in accordance with one or more techniques of this disclosure.

FIG. 3 is a flowchart illustrating a method of graphics processing with GPU program multi-versioning according to one or more techniques of this disclosure.

FIG. 4 is a flowchart illustrating a method of graphics processing with GPU program multi-versioning based on multiple selected resources according to one or more techniques of this disclosure.

FIG. 5 is a continuation of the flowchart of FIG. 4.

### DETAILED DESCRIPTION

In general, examples disclosed herein provide techniques and apparatuses for utilizing GPU program multi-versioning to provide relatively efficient operation based on hardware resource allocation and/or resource characteristics which are not known at the time of compilation of the versions of the GPU program. For example, different versions of the GPU program may be generated which access resources on different hardware resources (e.g., on a fast shared resource or on a global memory). The GPU program version used may depend on the hardware resources allocated for the GPU program runtime and characteristics of the resource at runtime. For example, the GPU program may be selected based on the size of the hardware resources allocated, and whether the resource can be stored on the allocated hardware resources.

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, as used herein, the term “graphical content” may refer to a content produced by a graphics processing unit.

In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended.

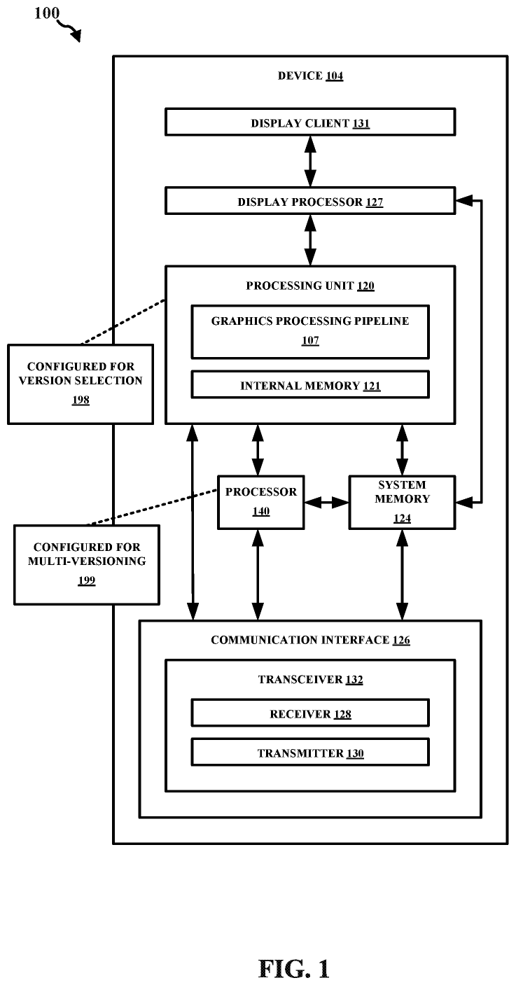

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of an SOC. The device 104 may include one or more components configured to perform one or more techniques of this disclosure. In the example shown, the device 104 may include a processing unit 120, a processor 140, and a system memory 124. In some aspects, the device 104 can include a number of optional components, e.g., a communication interface 126, a transceiver 132, a receiver 128, a transmitter 130, a display processor 127, and a display client 131. Reference to the display client 131 may refer to one or more displays. For example, the display client 131 may include a single display or multiple displays. The display client 131 may include a first display and a second display. In further examples, the results of the graphics processing may not be displayed on the device, e.g., the first and second displays may not receive any frames for presentment thereon. Instead, the frames or graphics processing results may be transferred to another device. In some aspects, this can be referred to as split-rendering.

The processing unit 120 may include an internal memory 121. The processing unit 120 may be configured to perform graphics processing, such as in a graphics processing pipeline 107. In some examples, the device 104 may include a display processor, such as the display processor 127, to perform one or more display processing techniques on one or more frames generated by the processing unit 120 before presentment by the display client 131. The display processor 127 may be configured to perform display processing. For example, the display processor 127 may be configured to perform one or more display processing techniques on one or more frames generated by the processing unit 120. The display client 131 may be configured to display or otherwise present frames processed by the display processor 127. In some examples, the display client 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120, such as system memory 124, may be accessible to the processing unit 120. For example, the processing unit 120 may be configured to read from and/or write to external memory, such as the system memory 124. The processing unit 120 may be communicatively coupled to the system memory 124 over a bus. In some examples, the processing unit 120 and the system memory 124 may be communicatively coupled to each other over the bus or a different connection.

It should be appreciated that in some examples, the device 104 may include a content encoder/decoder configured to receive graphical and/or display content from any source, such as the system memory 124 and/or the communication interface 126. The system memory 124 may be configured to store received encoded or decoded graphical content. In some examples, the content encoder/decoder may be configured to receive encoded or decoded graphical content, e.g., from the system memory 124 and/or the communication interface 126, in the form of encoded pixel data. In some examples, the content encoder/decoder may be configured to encode or decode any graphical content.

The internal memory 121 or the system memory 124 may include one or more volatile or non-volatile memories or storage devices. In some examples, internal memory 121 or the system memory 124 may include RAM, SRAM, DRAM, erasable programmable ROM (EPROM), electrically erasable programmable ROM (EEPROM), flash memory, a magnetic data media or an optical storage media, or any other type of memory.

The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the device 104. In some examples, the processing unit 120 may be present on a graphics card that is installed in a port in a motherboard of the device 104, or may be otherwise incorporated within a peripheral device configured to interoperate with the device 104. The processing unit 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

In some aspects, the content generation system 100 can include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

In some examples, the graphical content from the processing unit 120 for display via the display client 131 is not static and may be changing. Accordingly, the display processor 127 may periodically refresh the graphical content displayed via the display client 131. For example, the display processor 127 may periodically retrieve graphical content from the system memory 124, where the graphical content may have been updated by the execution of an application (and/or the processing unit 120) that outputs the graphical content to the system memory 124.

The rate at which the display processor 127 refreshes the graphical content displayed via the display client 131 may be referred to as the frames per second (FPS) rate or the “display refresh rate.” Examples of the display refresh rate include 30 fps, 60 fps, 90 fps, 120 fps, 240 fps, etc.

Referring again to FIG. 1, in certain aspects, the processor 140 may be configured to dynamically generate different versions of a GPU program based on hardware resources allocated to the GPU program at runtime (e.g., at the time the GPU program is executed), as illustrated at 199. For example, the processor 140 may be configured to generate a first version of a GPU program that accesses a resource from a global memory of the processing unit 120 and a second version of the GPU program that access the resource from a fast shared resource of the processing unit 120. The processing unit 120 may be configured to select a version of the GPU program generated by the processor 140, as illustrated at 198. For example, the processing unit 120 may utilize the first version of the GPU program if the resource cannot be stored on the fast shared resource allocated to the GPU program at run time, and may utilize the second version of the GPU program if the resource can be stored on the fast shared resource allocated to the GPU program at run time.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein. Processes herein may be described as performed by a particular component (e.g., a GPU), but, in further embodiments, can be performed using other components (e.g., a CPU), consistent with disclosed embodiments.

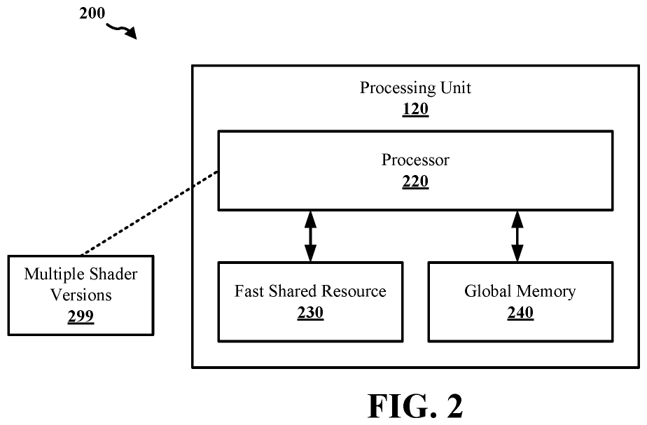

FIG. 2 is a diagram illustrating an example embodiment of the processing unit 120 of FIG. 1.

The processing unit 120 may include a processor 220, a fast shared resource 230, and a global memory 240. In performing graphics processing, such as in the graphics processing pipeline 107, the processor 220 may execute graphical processing instructions. The processor 220 may be configured to utilize hardware resources, including the fast shared resource 230 and the global memory 240. The fast shared resource 230 and the global memory 240 may store data and the processor 220 may access the data stored on the fast shared resource 230 and/or the global memory 240 in executing the graphical processing instructions. The fast shared resource 230 may be a resource having a faster access speed than the global memory 240. For example, the fast shared resource 230 may be a constant register or a set of constant registers, or may be a local memory. In some aspects, the processor 220 may utilize memory access instructions to access resources stored on the global memory 240, whereas the processor 220 may not need to utilize a memory access instruction to access resources stored on the fast shared resource 230. The processor 220 may be able to access resource stored on the fast shared resource 230 faster than it can access resources stored on the global memory 240 (e.g., in some aspects, on the order of 100 times faster). In some aspects, the fast shared resource 230 may be a memory resource that resides on the same chip as the processor 220 and the global memory 230 may be a memory resource that does not reside on the same chip as the processor 220 but is connected to the chip of the processor 220.

The processor 220 may execute a GPU program. A GPU program may be a shader or a kernel. A shader may be an application which applies an effect (e.g., a visual effect) to graphical content. Shaders may be used to apply visual effects such as shading, alteration of light levels, or smoothing of 3D models, and are often used in games or video processing. However, shaders can be used to apply other effects in other use cases, and are not limited to the provided examples. A kernel may be a program that is compiled to execute on accelerators. A kernel may use GPU hardware directly through a programming interface such as OpenCL.

The processor 220 may receive input data, and may execute the GPU program to transform the input data. At runtime, the processing unit 120 may allocate hardware resources, including portions of the fast shared resource 230 and the global memory 240, for the processor 220 to utilize for executing the GPU program. Resources, such as textures, images, or buffers (e.g., read-only shader storage buffer objects, constant buffer), may be stored on the hardware resources allocated to the GPU program, and the processor 220 may access the resources and use them during execution of the GPU program.

A GPU program may include multiple threads, and multiple threads of the GPU program may access the same resource. Storing a resource accessed by multiple threads (or all threads) of a GPU program on a hardware resource with a relatively short access latency (e.g., the fast shared resource 230), as compared to a hardware resource with a relatively long access latency (e.g., the global memory) can reduce memory access overhead. However, the size of the resource may not be known at the time that the GPU program is compiled. For example, where the resource is a texture, the size of the texture may not be known at the time the GPU program is compiled. Further, the space available for the resource in the allocated hardware resources may not be known until the hardware resources are allocated (e.g., at runtime).

In some aspects, as illustrated at 299, the processor 220 may be configured to execute multiple versions of a GPU program. The different versions of the GPU program may be configured to store a resource on different hardware resources and access the resource from those hardware resources. For example, a first version of the GPU program may store a resource on the fast shared resource 230 and access the resource from the fast shared resource 230, and a second version of the GPU program may store the resource on the global memory 240 and access the resource from the global memory 240. The processor 220 may determine which version of the GPU program to execute based on the hardware resources allocated to the GPU program and/or the properties of the resource at runtime. The multiple GPU program versions will be discussed in more detail below.

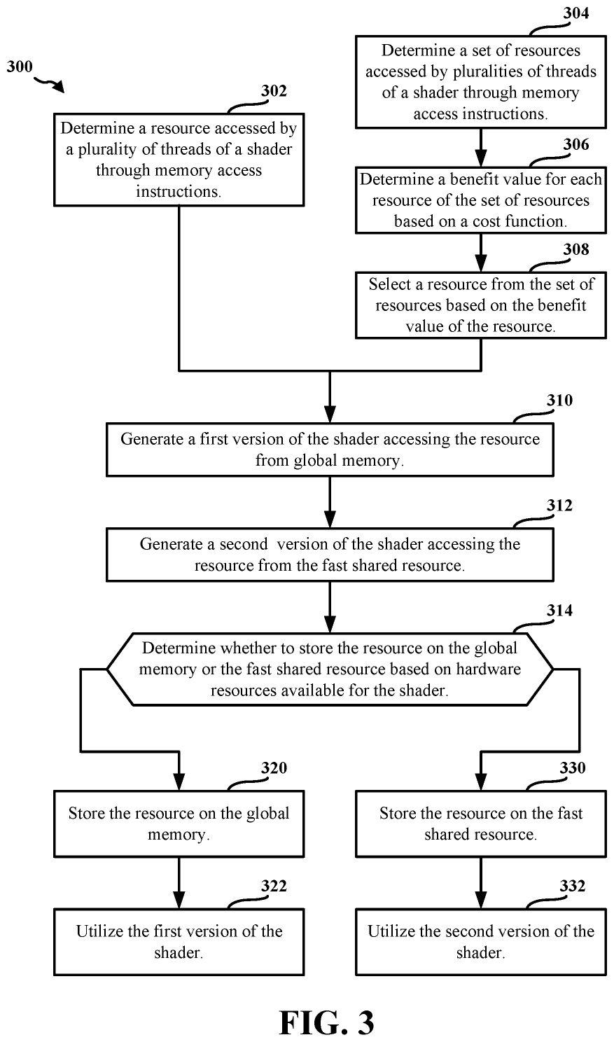

FIG. 3 is a flowchart 300 illustrating a method of graphical processing with GPU program multi-versioning. The method of FIG. 3 may be performed by a processor such as the processor 140 of FIG. 1 and a processing unit such as the processing unit 120 of FIG. 1.

In some aspects, as illustrated at 302, the processor may determine a resource accessed by a plurality of threads of a GPU program through memory access instructions. For example, the processor may examine the memory access instructions of the GPU program and determine whether there is a resource for which a plurality of threads include a memory access instruction accessing the resource, and select that resource. In some aspects, the processor may select a resource that the plurality of threads access uniformly. For example, the processor may determine that each thread of the plurality of threads has a uniform coordinate and/or offset for the resource. In some aspects, the processor may select a resource that is accessed by all threads of the GPU program.

Table 1 below illustrates a portion of an example GPU program. Table 2 below illustrates code generated for the memory access instructions illustrated in the GPU program of Table 1. Each of the threads in the portion of the example GPU program access resource t4 with uniform coordinates. Accordingly, the processor may select resource t4.

```
TABLE 1
dcl_resource_structured t4, 16
  ...
  ld_structured_indexable(structured_buffer, stride=16) r1.xyz, l(0),
  l(0), t4.xyzx
  // use of r1
  ld_structured_indexable(structured_buffer, stride=16) r6.xyz, l(1),
  l(0), t4.xyzx
  // use of r6
  ld_structured_indexable(structured_buffer, stride=16) r2.xyz, l(2),
  l(0), t4.xyzx
  // use of r2
  ld_structured_indexable(structured_buffer, stride=16) r3.xyz, l(3),
  l(0), t4.xyzx
  // use of r3
```

...

ret

TABLE 1

mov.s32s32 r0.w, 0;
mov.s32s32 r1.y, 0;
mov.s32s32 r1.w, 0;
mov.s32s32 r2.y, 1;
mov.s32s32 r2.w, 0;
mov.s32s32 r3.y, 2;
mov.s32s32 r3.w, 0;
mov.s32s32 r4.y, 3;
isam (f32)(xyzO)r0.z, r0.w, 0;
isam (f32)(xyzO)r1.z, r1.w, 0;
isam (f32)(xyzO)r2.z, r2.w, 0;
isam (f32)(xyzO)r3.z, r3.w, 0;
// use of r0, r1, r2, r3
...
ret

In some aspects, as illustrated at 304, the processor may determine a set of resources accessed by pluralities of threads of a GPU program through memory instructions. For example, the processor may select multiple resources in the manner described above illustrated at 302, each resource being accessed by a plurality of threads of the GPU program (e.g., the same plurality or a different plurality). Upon determining the set of resources, the processor may determine a benefit value for each resource of the set of resources based on a cost function, as illustrated at 306. The benefit value for a given resource may correspond to the benefit of accessing the resource from a fast shared resource (e.g., the fast shared resource 230 of FIG. 2) instead of accessing the resource from a global memory (e.g., the global memory 240 of FIG. 2).

In some aspects, the processor may determine the number of memory access instructions which would be avoided by accessing the resource from the fast shared resource instead of the global memory, and determine the benefit value based on the number of memory access instructions. In some aspects, the processor may determine the memory access bandwidth which would be saved by accessing the resource from the fast shared resource instead of the global memory, and determines the benefit value based on the saved memory access bandwidth. In some aspects, the processor may determine the register use saved by accessing the resource from the fast shared resource instead of the global memory, and determine the benefit value based on the saved register use. For example, the cost function may be: benefit value=factor1*0.4+factor2*0.2+factor3*0.4, where factor 1 is the ratio of the number of reduced memory access instructions to the number of all memory access instructions, factor 2 is ratio of saved memory access bandwidth to total memory access bandwidth, and factor 3 is the ratio of saved register use to total register use.

Upon determining a benefit value for each resource of the set of resources, the processor may select a resource from the set of resources based on the benefit value of the resource, as illustrated at 308. For example, the processor may select the resource with the highest benefit value.

At 310, once a resource has been selected, the processor may generate a first version of the GPU program. The first version of the GPU program may access the resource from the global memory (e.g., using memory access instructions). In some aspects, the processor may have selected the resource at 302 or 304 based on the high-level code (e.g., the source code) of the GPU program, and generating the first version of the GPU program may be generating (e.g., compiling) a lower-level (e.g., machine readable) version of the high-level code of the GPU program, without deviating from the original coding of the GPU program.

At 312, the processor may generate a second version of the GPU program. The second version of the GPU program may access the resource from the fast shared resource (e.g., directly access without using memory access instructions). In some aspects, the second version of the GPU program may deviate from the original coding of the GPU program to replace the memory access instructions accessing the resource with commands directly accessing the resource from the fast shared resource, and compiling this altered version. The second version of the GPU program may also be in a lower-level (e.g., machine readable) code. Through reduced memory access instructions, memory access bandwidth, and/or register use, the second version of the GPU program may use less power or may have a lower latency than the first version of the GPU program. The processor may transmit the first version of the GPU program and the second version of the GPU program to the processing unit, and the processing unit may receive the first version of the GPU program and the second version of the GPU program from the processor.

At 314, the processing unit determines whether to store the resource on the global memory or the fast shared resource based on hardware resources available for the GPU program. The determination may be made based on aspects of the resource which were not set at 312, when the second version of the GPU program was generated. For example, the resource may be a texture and the determination may be based on the size of the texture identified at runtime. The determination may be made based on hardware resources allocated to the GPU program at runtime. The processing unit may determine how much space is available for use by the GPU program on the fast shared resource. The processing unit may determine whether the resource can be stored on the fast shared resource based on the space available for use by the GPU program (e.g., if the space available is larger than the size of the resource, or the space available is large enough for the resource and other aspects of the GPU program to be stored on the fast shared resource). If so, at 320, the processing unit may store the resource on the fast shared resource. If not, at 330, the processing unit may store the resource on the global memory.

At 322, if the resource was stored on the global memory at 320, the processing unit utilizes the first version of the GPU program, accessing the resource from the global memory (e.g., through memory access instructions).

At 332, if the resource was stored on the fast shared resource at 320, the processing unit utilizes the second version of the GPU program, accessing the resource from the fast shared resource (e.g., direct access without memory access instructions). The processing unit may therefore benefit from the reduced power consumption or improved latency associated with the second version of the GPU program where adequate hardware resources are allocated to the GPU program at runtime, but may still operate using the first version of the GPU program based on the original GPU program code when adequate hardware resources are not available.

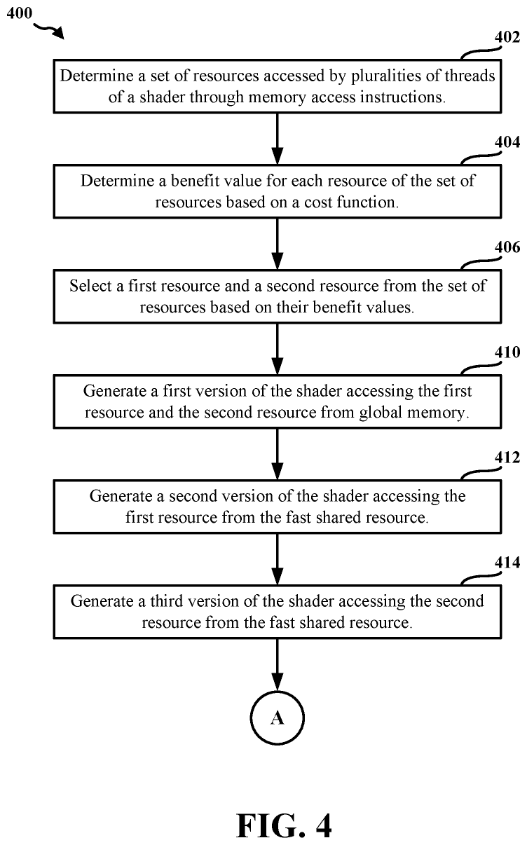

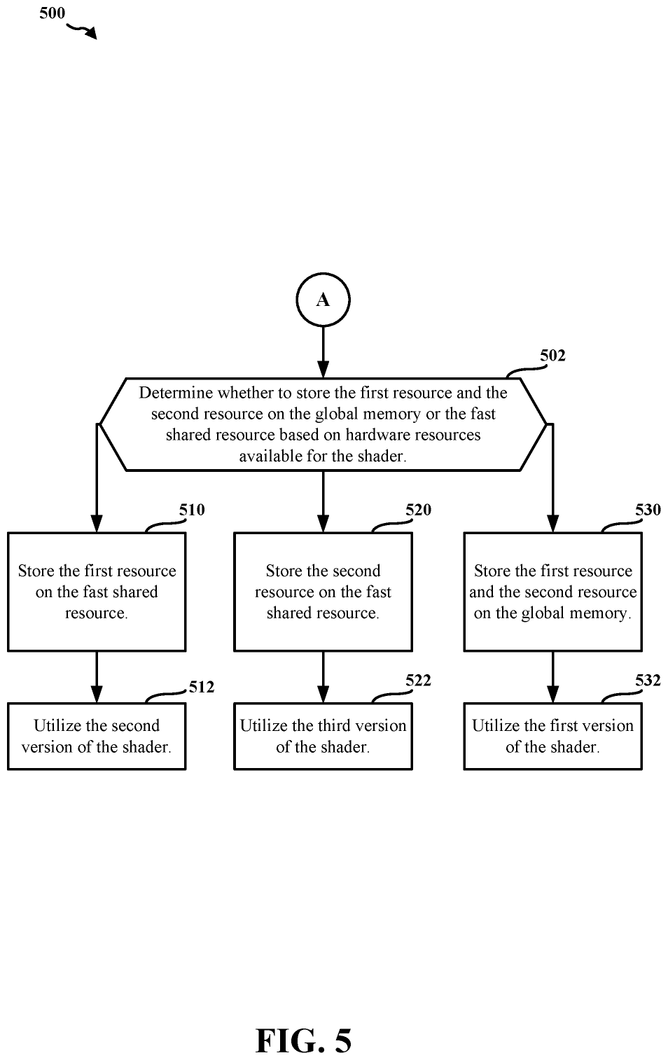

FIG. 4 and FIG. 5 are flowcharts 400 and 500 illustrating a method of graphical processing with GPU program multi-versioning based on multiple selected resources. The method of FIGS. 4 and 5 may be performed by a processor such as the processor 140 of FIG. 1 and a processing unit such as the processing unit 120 of FIG. 1.

At 402, the processor may determine a set of resources accessed by pluralities of threads of a GPU program through memory access instructions. For example, the processor may examine the memory access instructions of the GPU program and determine resources which are accessed through memory access instructions in a plurality of threads. The plurality of threads may be the same for each determined resource, or may be different for each determined resource. The processor may select those resources as the set of resources. In some aspects, the processor may select resources that pluralities of threads access uniformly. In some aspects, the processor may select resources that are accessed by all threads of the GPU program.

At 404, upon determining the set of resources, the processor may determine a benefit value of each resource of the set of resources. The processor may determine the benefit values based on a cost function, as described above with respect to 306 of FIG. 1.

At 406, the processor may select a first resource and a second resource from the set of resources. The processor may select the first resources and the second resource based on their benefit values determined at 404. In some aspects, the processor may select the two resources of the set of resources with the highest benefit value. In some aspects, two resources of the set of resources may have a similar high benefit value, and the processor may select those two resources as the first resource and the second resource. For example, two resources of the set of resources may have a similar high value if the second highest benefit value is less than ten percent lower than the highest benefit value. As another example, two resources of the set of resources may have a similar high value if both of the two resources have a benefit value of at least 0.9.

In some aspects, at 410, the processor may generate a first version of the GPU program accessing the first resource and the second resource from a global memory of the processing unit (e.g., using memory access instructions). In some aspects, the processor may have selected the set of resources at 402 based on the high-level code (e.g., the source code) of the GPU program, and generating the first version of the GPU program may be generating a lower-level (e.g., machine readable) version of the high-level code of the GPU program, without deviating from the original coding of the GPU program.

At 412, the processor may generate a second version of the GPU program accessing the first resource from a fast shared resource of the processing unit (e.g., directly accessing the first resource without using memory access instructions). In some aspects, the second version of the GPU program may deviate from the original coding of the GPU program to replace the memory access instructions accessing the first resource with commands directly accessing the first resource from the fast shared resource, and compiling this altered version. The second version of the GPU program may access the second resource from the global memory. The second version of the GPU program may also be in a lower-level (e.g., machine readable) code.

At 414, the processor may generate a third version of the GPU program accessing the second resource from the fast shared resource of the processing unit (e.g., directly accessing the second resource without using memory access instructions). In some aspects, the third version of the GPU program may deviate from the original coding of the GPU program to replace the memory access instructions accessing the second resource with commands directly accessing the second resource from the fast shared resource, and compiling this altered version. The third version of the GPU program may access the first resource from the global memory. The third version of the GPU program may also be in a lower-level (e.g., machine readable) code. The processor may transmit the second version of the GPU program and the third version of the GPU program to the processing unit, and the processing unit may receive the second version of the GPU program and the third version of the GPU program from the processor. In some aspects, the processor may transmit the first version of the GPU program to the processing unit and the processing unit may receive the first version of the GPU program from the processor.

At 502, the processing unit may determine whether to store the first resource and the second resource on the global memory or the fast shared resource based on hardware resources available for the GPU program. The determination may be made based on aspects of the resource which were not set at 412 or 414, when the second version of the GPU program and the third version of the GPU program were generated. For example, the first resource and the second resource may be textures and the determination may be based on the size of the textures identified at runtime. The determination may be made based on hardware resources allocated to the GPU program at runtime.

The processing unit may determine how much available space on the fast shared resource is allocated for the GPU program, and may determine whether the first resource or the second resource can be stored in the available space (e.g., determine if the size of the first resource or the second resource, determined at runtime, is less than or equal to the available space). If the first resource can be stored on the available space on the fast shared resource but the second resource cannot be stored on the available space on the fast shared resource, the processing unit may store the first resource on the fast shared resource as illustrated at 510, and in some aspects may store the second resource on the global memory. If the second resource can be stored on the available space on the fast shared resource but the first resource cannot be stored on the available space on the fast shared resource, the processing unit may store the second resource on the fast shared resource as illustrated at 520, and in some aspects may store the first resource on the global memory.

If both the first resource and the second resource can be stored on the available space on the fast shared resource, the processing unit may select one of the resources to store on the constant memory based on the benefit values of the first resource and the second resource. If the first resource has the higher benefit value, the processing unit may store the first resource on the fast shared resource as illustrated at 510, and in some aspects may store the second resource on the global memory. If the second resource has the higher benefit value, the processing unit may store the second resource on the fast shared resource as illustrated at 520, and in some aspects may store the first resource on the global memory.

At 512, if the first resource was to be stored on the fast shared resource at 510, the processing unit utilizes the second version of the GPU program, accessing the first resource from the fast shared resource (e.g., direct access without memory access instructions). The processing unit may access the second resource from the global memory.

At 522, if the second resource was to be stored on the fast shared resource at 520, the processing unit utilizes the third version of the GPU program, accessing the second resource from the fast shared resource (e.g., direct access without memory access instructions). The processing unit may access the first resource from the global memory.

In some aspects, as illustrated at 530, the processing unit may store the first resource and the second resource on the global memory. For example, at 502, if neither the first resource nor the second resource can be stored on the available space on the fast shared resource, the processing unit may store both the first resource and the second resource on the global memory. At 532, the processing unit may then utilize the first version of the GPU program generated at 410, accessing the first resource and the second resource from the global memory (e.g., using memory access instructions).

The method of graphical processing described with respect to FIGS. 4 and 5 includes a first and a second resource, and GPU program versions corresponding to each of the first and the second resource. However, the present disclosure is not limited thereto. In some aspects, a method of graphical processing may include a processor selecting more than two resource, and generating a GPU program version corresponding to each selected resource, accessing that selected resource from a fast shared resource of the processing unit.

In one configuration, a method or apparatus for display processing is provided. The apparatus may be a display processor, a display processing unit (DPU), a GPU, a video processor, or some other processor that can perform display processing. In some examples, the apparatus may be the processor 140 within the device 104, or may be some other hardware within the device 104, or another device. The apparatus may include means for determining a set of resources, wherein each resource of the set of resources is accessed by a plurality of threads of a GPU program through memory access instructions, such as the processor 140. The apparatus may include means for generating a first version of the GPU program accessing a resource of the set of resources from a global memory, such as the processor 140. The apparatus may include means for generating a second version of the GPU program accessing the resource from a fast shared resource, such as the processor 140. The apparatus may include means for transmitting the first version of the GPU program and the second version of the GPU program to a processing unit (e.g., the processing unit 120, or the processor 220 of the processing unit 120), such as the processor 140.

In some aspects, the apparatus may include means for determining a benefit value for each resource of the set of resources based on a cost function, such as the processor 140. In some aspects, the apparatus may include means for selecting the resource from the set of resources based on the benefit value of the resource, such as the processor 140.

In some aspects, the apparatus may include means for determining a benefit value for each resource of the set of resources based on a cost function, such as the processor 140. The apparatus may include means for selecting the resource from the set of resources based on the benefit value of the resource, means for selecting a second resource from the set of resources based on the benefit value of the second resource, means for generating a third version of the GPU program accessing the second resource from the fast shared resource and means for transmitting the third version of the GPU to the processing unit, such as the processor 140.

In another configuration, a method or apparatus for display processing is provided. The apparatus may be a display processor, a display processing unit (DPU), a GPU, a video processor, or some other processor that can perform display processing. In some examples, the apparatus may be the processing unit 120 within the device 104, the processor 220 within the processing unit 120, or may be some other hardware within the device 104, or another device. The apparatus may include means for receiving the first version of the GPU program and the second version of the GPU program from a processor (e.g., the processor 140), such as the processing unit 120 or the processor 220. The apparatus may include means for determining whether to store the resource on the global memory or the fast shared resource based on hardware resources available for the GPU program, such as the processing unit 120 or the processor 220. The apparatus may include means for utilizing the second version of the GPU program if the resource is to be stored on the fast shared resource, such as the processing unit 120 or the processor 220.

In some aspects, the apparatus may include means for utilizing the first version of the GPU program if the resource is to be stored on the global memory, such as the processing unit 120 or the processor 220.

In some aspects, the apparatus may include means for receiving a third version of the GPU program accessing a second resource from the fast shared resource, such as the processing unit 120 or the processor 220. In some aspects, the apparatus may include means for determining whether to store the second resource on the global memory or the fast shared resource based on the hardware resources available for the GPU program, and means for utilizing the third version of the GPU program if the second resource is to be stored on the fast shared resource, such as the processing unit 120 or the processor 220. In some aspects, the apparatus may include means for utilizing the first version of the GPU program if the resource and the second resource are both stored on the global memory, wherein the first version of the GPU program accesses the resource and the second resource from the global memory, such as the processing unit 120 or the processor 220.

The subject matter described herein can be implemented to realize one or more benefits or advantages. For example, the above-described apparatuses and methods of graphical processing may reduce the latency of execution of a GPU program or reduce the power usage associated with execution of the GPU program. The above-described apparatuses and methods of graphical processing may also reduce register use, which may increase the number of threads that a processing unit may run in parallel. Further, the above-described apparatuses and methods of graphical processing may allow for simplification of programming of the GPU program, as the programmer may achieve the benefits of efficient runtime hardware utilization without a full understanding of the hardware details of the processing unit (e.g., the GPU) executing the GPU program.

In accordance with this disclosure, the term “or” may be interrupted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. By way of example, and not limitation, such computer-readable media can comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of interoperative hardware units, including one or more processors as described above, in conjunction with suitable software and/or firmware.

Various examples have been described. These and other examples are within the scope of the following claims.

What is claimed is:

1. An apparatus for graphics processing, comprising:
a memory; and
at least one processor coupled to the memory and configured to:
determine a set of resources, wherein each resource of the set of resources is accessed by a plurality of threads of a graphics processing unit (GPU) program through memory access instructions;
generate a first version of the GPU program accessing a resource of the set of resources from a global memory;
generate a second version of the GPU program accessing the resource from a fast shared resource; and
transmit the first version of the GPU program and the second version of the GPU program to a second processor.

2. The apparatus of claim 1, wherein the second processor is configured to:
determine whether to store the resource on the global memory or the fast shared resource based on hardware resources available for the GPU program; and
utilize the second version of the GPU program if the resource is to be stored on the fast shared resource.

3. The apparatus of claim 2, wherein the second processor is configured to:
utilize the first version of the GPU program if the resource is to be stored on the global memory.

4. The apparatus of claim 1, wherein the processor is further configured to:
determine a benefit value for each resource of the set of resources based on a cost function; and
select the resource from the set of resources based on the benefit value of the resource.

5. The apparatus of claim 4, wherein the cost function is based on a number of reduced memory access instructions associated with storing the resource on the fast shared resource, an amount of saved memory access bandwidth associated with storing the resource on the fast shared resource, or an amount of reduced register use associated with storing the resource on the fast shared resource.

6. The apparatus of claim 1, wherein the processor is further configured to:
determine a benefit value for each resource of the set of resources based on a cost function;
select the resource from the set of resources based on the benefit value of the resource;
select a second resource from the set of resources based on the benefit value of the second resource; and
generate a third version of the GPU program accessing the second resource from the fast shared resource, wherein the second processor is configured to:
determine whether to store the second resource on the global memory or the fast shared resource based on the hardware resources available for the GPU program; and
utilize the third version of the GPU program if the second resource is to be stored on the fast shared resource.

7. The apparatus of claim 6, wherein the second processor is configured to:
utilize the first version of the GPU program if the resource and the second resource are both to be stored on the global memory, wherein the first version of the GPU program accesses the resource and the second resource from the global memory.

8. The apparatus of claim 6, wherein the processor is configured to select the resource from the set of resources and select the second resource from the set of resources by determining that the benefit value of the resource and the benefit value of the second resource both exceed a threshold value.

9. The apparatus of claim 6, wherein the processor is configured to select the second resource from the set of resources by determining that the benefit value of the second resource is at least a threshold percentage of the benefit value of the first resource.

10. The apparatus of claim 1, wherein each resource of the set of resources is uniformly accessed by the plurality of threads of the GPU program.

11. The apparatus of claim 1, wherein the resource is a texture or a buffer.

12. An apparatus for graphics processing, comprising:
a memory; and
at least one processor coupled to the memory and configured to:
receive a first version of a graphics processing unit (GPU) program and a second version of the GPU program, the first version of the GPU program being configured to access a resource from a global memory, the second version of the GPU program being configured to access the resource from a fast shared resource;
determine whether to store the resource on the global memory or the fast shared resource based on hardware resources available for the GPU program; and
utilize the second version of the GPU program if the resource is to be stored on the fast shared resource.

13. The apparatus of claim 12, wherein the processor is further configured to:
utilize the first version of the GPU program if the resource is to be stored on the global memory.

14. The apparatus of claim 12, wherein the first version of the GPU program and the second version of the GPU program are received from a second processor configured to:
determine a set of resources comprising the resource, wherein each resource of the set of resources is accessed by a plurality of threads of the GPU program through memory access instructions;
generate the first version of the GPU program accessing the resource from the global memory; and
generate the second version of the GPU program accessing the resource from the fast shared resource.

15. The apparatus of claim 14, wherein each resource of the set of resources is uniformly accessed by the plurality of threads of the GPU program.

16. The apparatus of claim 14, wherein the second processor is configured to:
determine a benefit value for each resource of the set of resources based on a cost function; and
select the resource from the set of resources based on the benefit value of the resource.

17. The apparatus of claim 16, wherein the cost function is based on a number of reduced memory access instructions associated with storing the resource on the fast shared resource, an amount of saved memory access bandwidth associated with storing the resource on the fast shared resource, or an amount of reduced register use associated with storing the resource on the fast shared resource.

18. The apparatus of claim 12, wherein the processor is further configured to:
receive a third version of the GPU program accessing a second resource from the fast shared resource;
determine whether to store the second resource on the global memory or the fast shared resource based on the hardware resources available for the GPU program; and
utilize the third version of the GPU program if the second resource is to be stored on the fast shared resource.

19. The apparatus of claim 18, wherein the processor is further configured to:
utilize the first version of the GPU program if the resource and the second resource are both to be stored on the global memory, wherein the first version of the GPU program accesses the resource and the second resource from the global memory.

20. The apparatus of claim 12, wherein the resource is a texture or a buffer.

21. A method of graphical processing, comprising:
determining a set of resources, wherein each resource of the set of resources is accessed by a plurality of threads of a graphics processing unit (GPU) program through memory access instructions;
generating a first version of the GPU program accessing a resource of the set of resources from a global memory;
generating a second version of the GPU program accessing the resource from a fast shared resource; and
transmitting the first version of the GPU program and the second version of the GPU program to a processing unit.

22. The method of claim 21, further comprising:
determining a benefit value for each resource of the set of resources based on a cost function;
selecting the resource from the set of resources based on the benefit value of the resource.

23. The method of claim 21, wherein the cost function is based on a number of reduced memory access instructions associated with storing the resource on the fast shared resource, an amount of saved memory access bandwidth associated with storing the resource on the fast shared resource, or an amount of reduced register use associated with storing the resource on the fast shared resource.

24. The method of claim 21, further comprising:
determining a benefit value for each resource of the set of resources based on a cost function;
selecting the resource from the set of resources based on the benefit value of the resource; selecting a second resource from the set of resources based on the benefit value of the second resource; and
generating a third version of the GPU program accessing the second resource from the fast shared resource.

25. The method of claim 24, wherein selecting the resource from the set of resources based on the benefit value of the resource and selecting a second resource from the set of resources based on the benefit value of the second resource comprises:
determining that the benefit value of the resource and the benefit value of the second resource both exceed a threshold value.

26. The method of claim 24, wherein selecting the resource from the set of resources based on the benefit value of the resource and selecting a second resource from the set of resources based on the benefit value of the second resource comprises:
determining that the benefit value of the second resource is at least a threshold percentage of the benefit value of the second resource.

27. The method of claim 21, wherein each resource of the set of resources is uniformly accessed by the plurality of threads of the GPU program.

28. The method of claim 21, wherein the resource is a texture or a buffer.
